(19) United States
(12) Patent Application Publication
(10) Pub. No.: US 2011/0236578 A1
(43) Pub. Date: Sep. 29, 2011

(54) PASTE APPLICATOR AND PASTE APPLYING METHOD

(75) Inventors: Tomohiro Matsui, Yokohama-shi (JP); Masaaki Furuya, Yokohama-shi (JP)

(73) Assignee: Kabushiki Kaisha Toshiba, Tokyo (JP)

(21) Appl. No.: 13/038,542

(22) Filed: Mar. 2, 2011

(30) Foreign Application Priority Data
Mar. 23, 2010 (JP) 2010-065910

(51) Int. Cl. B05D 5/00; B05C 11/00; B05C 9/00

(52) U.S. Cl. 427/256; 118/708

(57) ABSTRACT

According to one embodiment, a paste applicator includes a discharger, a driver, a detector, and a controller. The discharger discharges paste material toward a surface of an object to be applied. The driver relatively moves the object to be applied and the discharger along the surface of the object to be applied. The detector detects an application start point of the paste material discharged from the discharger and applied to the surface of the object to be applied. The controller controls the discharger and the driver so that the paste material is applied to the object to be applied in a form of a closed ring. The controller sets an application terminating operation start point of the paste material in accordance with the application start point detected by the detector during the discharge of the paste material.

### CROSS-REFERENCE TO RELATED APPLICATION

This application is based upon and claims the benefit of priority from Japanese Patent Application No. 2010-065910, filed on Mar. 23, 2010; the entire contents of which are incorporated herein by reference.

### FIELD

Embodiments described herein relate generally to a paste applicator and a paste applying method.

### BACKGROUND

The manufacturing process of a flat panel display (FPD), for example, a liquid crystal display (LCD), a plasma display panel (PDP), an organic light-emitting diode (OLED), or the like, includes a bonding process for bonding two glass substrates. In the bonding process, before glass substrates are bonded, paste material, for example, UV curable resin, thermosetting resin, glass fit, or the like, is applied by drawing onto the glass substrate by a dispenser and a rectangular paste pattern is formed on the glass substrate.

### BRIEF DESCRIPTION OF THE DRAWINGS

FIG. 1 is an appearance perspective view illustrating a schematic configuration of a paste applicator in an embodiment.

FIG. 2 is an explanatory diagram for explaining a deviation in application start point.

FIG. 3 is an explanatory diagram for explaining a difference in the shape of application start point depending on the amount of application.

FIG. 4 is an explanatory diagram for explaining a difference in the shape of connection part depending on the deviation in application start point.

FIG. 5 is an explanatory diagram for explaining an application terminating operation (connecting operation) performed by the paste applicator illustrated in FIG. 1.

FIG. 6 is an explanatory diagram for explaining an agreement in the shape of connection part by the application terminating operation in FIG. 5.

FIG. 7 is an explanatory diagram for explaining parameter control in the application terminating operation in FIG. 5.

FIG. 8 is an explanatory diagram for explaining an applying operation performed by the paste applicator illustrated in FIG. 1.

### DETAILED DESCRIPTION

According to one embodiment, a paste applicator includes a discharger, a driver, a detector, and a controller. The discharger discharges paste material toward a surface of an object to be applied. The driver relatively moves the object to be applied and the discharger along the surface of the object to be applied. The detector detects an application start point of the paste material discharged from the discharger and applied to the surface of the object to be applied. The controller controls the discharger and the driver so that the paste material is applied to the surface of the object to be applied in a form of a closed ring. The controller sets an application terminating operation start point of the paste material according to the application start point detected by the detector during the period of discharge of the paste material.

Various Embodiments will be described hereinafter with reference to the accompanying drawings.

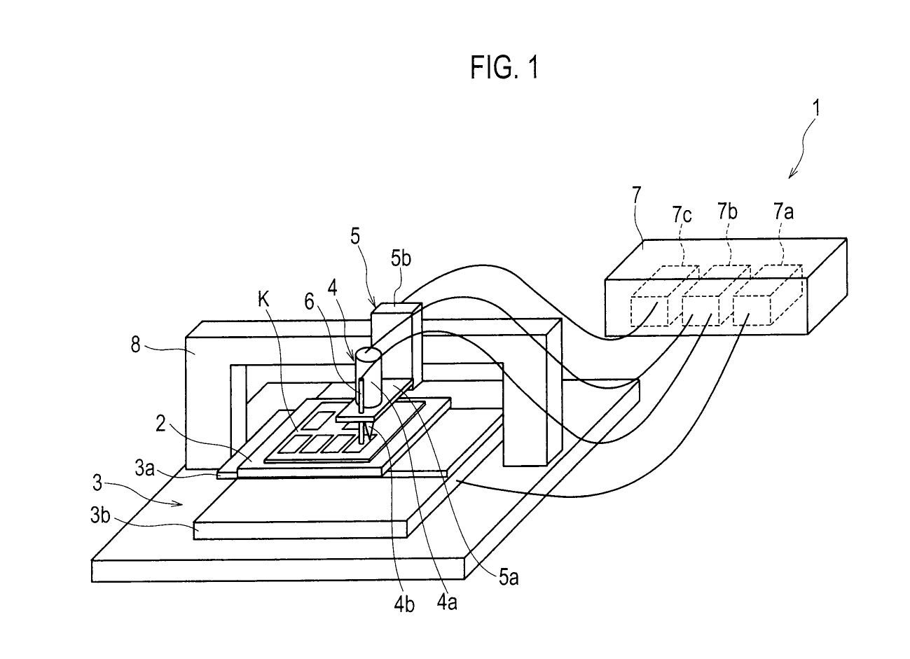

As illustrated in FIG. 1, a paste applicator 1 in an embodiment includes a stage 2, a stage driver 3, a discharge head 4, a head driver 5, a detection sensor 6, and a controller 7. The stage 2 mounts a substrate K as an object to be applied. The stage driver 3 holds the stage 2 and moves the stage 2 in an X axis direction and in a Y axis direction. The discharge head 4 discharges paste material toward the substrate K on the stage 2. The head driver 5 moves the discharge head 4 in a Z axis direction. The detection sensor 6 detects an application start point of the paste material applied to the substrate K on the stage 2. The controller 7 controls each section of the paste applicator 1.

The stage 2 is a table on which the substrate K such as a glass substrate is mounted, and is movably provided on the stage driver 3. The substrate K is held on the mounting surface of the stage 2 by a mechanism such as an electrostatic chuck, an adsorption chuck, or the like, but the mechanism is not limited to those and it may also be mounted only by its own weight.

The stage driver 3 includes an X axis moving mechanism 3a and a Y axis moving mechanism 3b, and guides and moves the stage 2 in the X axis direction and the Y axis direction. The stage driver 3 is electrically connected to the controller 7 and the controller 7 controls the drive of the stage 2. As the X axis moving mechanism 3a and the Y axis moving mechanism 3b, for example, the feed-screw mechanism that uses a servomotor as a drive source, the linear motor mechanism that uses a linear motor as a drive source, or the like, is used.

The discharge head 4 includes a syringe 4a that is a vessel for accommodating the paste material and a nozzle 4b for discharging the paste material accommodated in the syringe 4a. The discharge head 4 discharges the paste material within the syringe 4a from a tip end of the nozzle 4b by means of a gas supplied into the syringe 4a via a pipe such as a gas supply tube. The discharge head 4 functions as a discharger that discharges the paste material toward the surface of the substrate K.

Here, as the paste discharging mechanism, a pneumatic mechanism that pushes out the paste material from the tip end of the nozzle 4b by applying pressure to the paste material is used, but besides the above, it may also be possible to use, for example, a mechanical mechanism that sends out the paste material by rotating a screw, and the mechanism to be used is selected according to the characteristics of the paste material. Such a paste discharging mechanism is electrically connected to the controller 7, and the drive thereof is controlled by the controller 7. In addition, as the paste material, thermosetting resin, UV curable resin, glass frit, or the like, is selected and used according to the product.

The head driver 5 includes a holding member 5a that holds the discharge head 4 and a Z axis moving mechanism 5b that moves the holding member 5a in the Z axis direction, and guides and moves the discharge head 4 along with the holding member 5a in the Z axis direction. The head driver 5 is supported by a strut 8 in the shape of a gate, such as a column. The Z axis moving mechanism 5b is electrically connected to the controller 7, and the controller 7 controls the drive of the Z axis moving mechanism 5b. As the Z axis moving mechanism 5b, for example, the feed-screw mechanism that uses a servomotor as a drive source, the linear motor mechanism that uses a linear motor as a drive source, or the like, is used.

The detection sensor 6 as a detector detects the application start point of the paste material applied to the substrate K on the stage 2. The detection sensor 6 is provided to the holding member 5a of the head driver 5 so as to be capable of moving along with the movement of the discharge head 4, and is electrically connected to the controller 7. As the detection sensor 6, for example, an optical fiber sensor, a color discriminating sensor, a camera, or the like, is used. As the detection sensor 6, the use of a sensor capable of detecting the presence/absence of the paste material on the substrate K such as a glass substrate is only required, and a sensor capable of optimal detection is selected according to the characteristics of the paste material.

The controller 7 includes a stage control section 7a that controls the stage driver 3, an application control section 7b that controls the discharge head 4, and a head control section 7c that controls the head driver 5. Further, the controller 7 also includes a storage section that stores various programs such as an application program, various pieces of information, and the like and further an operation section that receives an input operation from an operator, and the like (neither are illustrated schematically).

The controller 7 controls the operation of each section of the paste applicator 1 based on the various programs, various pieces of information, and the like, stored in the storage section. In the storage section, information about application including a drawing pattern (application pattern), application conditions, and the like, is stored. Here, the application conditions include the application speed, application pressure (discharge pressure), information about the setting of a nozzle gap, and the like. Such information about application is stored in the storage section in advance by the input operation to the operation section and data communication, or via a portable storage device. As the storage section, a memory, a hard disc drive (HDD), or the like, is used.

When applying the paste material onto the substrate K, the paste applicator 1 moves the position of the discharge head 4 to a predetermined position according to the application program by the head driver 5, and then applies the paste material onto the substrate K through the discharge head 4 while moving the stage 2 on which the substrate K is mounted by the stage driver 3 in accordance with a drawing pattern.

In the application program, it is possible to set the conditions of one or more drawing patterns on the substrate K. The drawing pattern is created by arbitrarily combining lines and curves referred to as parts and has a configuration in which the application speed, application pressure, and nozzle gap can be set as control parameters for the respective parts. The above-mentioned control parameters are an example when the discharge head 4 is of pneumatic type. When the discharge head 4 is of mechanical type, the rotation speed and the amount of rotation of the screw that sends out the paste material may be set as control parameters.

When drawing the paste material on the substrate K, the paste applicator 1 issues instructions according to the drawing pattern to the stage control section 7a and the head control section 7c from the controller 7. After moving the discharge head 4 to the application start position set in the program while controlling the stage driver 3 and the head driver 5, transmits an application start signal to the discharge head 4 from the application control section 7b, and starts application. The application start position set in the program is a position set in advance by the application program.

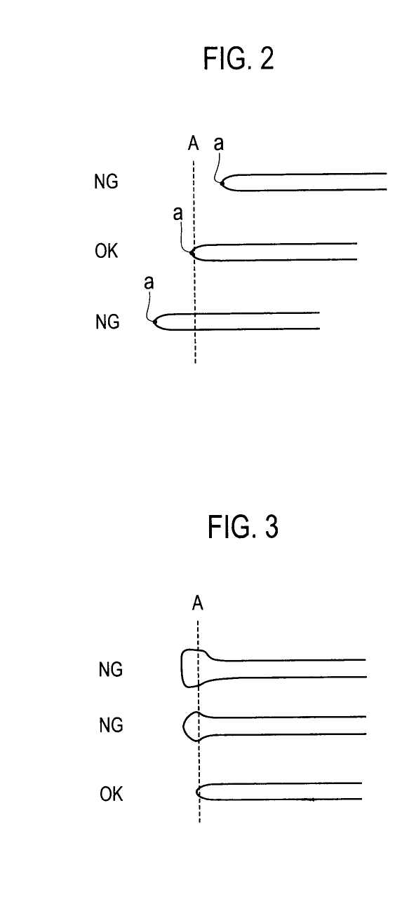

Here, as illustrated in FIG. 2, there is a case where an application start position A set in the program deviates from an actual application start point “a”, and furthermore, the amount of deviation is not fixed. This is a phenomenon caused by a plurality of overlapping factors, such as the characteristics of the paste material (viscosity, material composition, particle diameter, and the like), the amount of paste within the syringe 4a, and the difference in position of the paste within the nozzle 4b depending on the difference in a state of the previous application completion, and it is difficult to control the amount of deviation.

Further, it is known from experiments that if the paste material is discharged somewhat excessively in advance from the nozzle 4b in order to align the application start point each time pattern application is carried out and then application is started in such a state, the amount of the paste material at the application start position A is excessive and takes the shape of a ball, and therefore, it is not possible to keep the sectional shape of the applied paste material constant. It is very difficult to align the application start point each time pattern application is carried out, in a state where the sectional shape is kept constant only by means of the above-mentioned parameters.

In the normal application program, it is possible to specify the application start position A of the drawing pattern and an application terminating operation start position B even during periods other than application, for example, before production, and the paste material can be connected by overlapping the paste material.

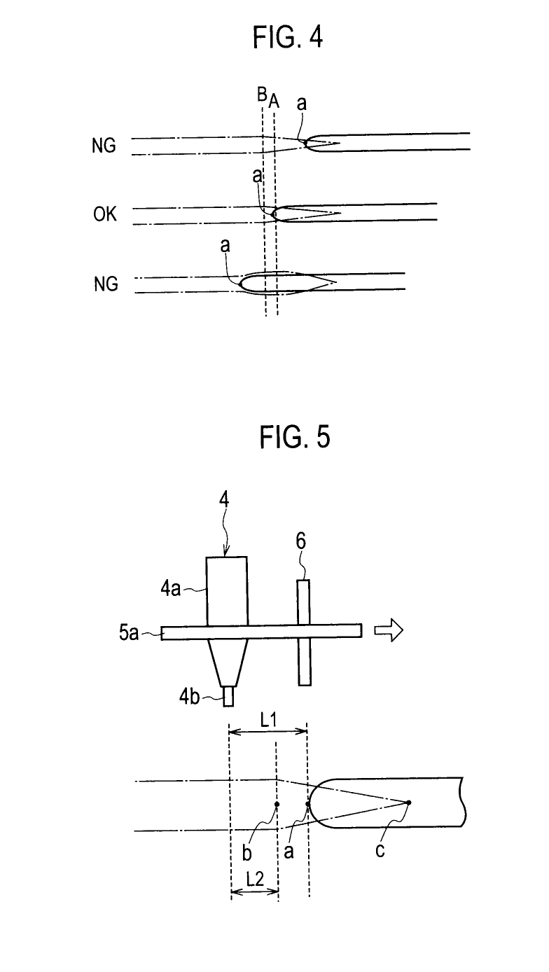

However, as illustrated in FIG. 4, the application terminating operation start position B is the same at all times also for the pattern (see the NG pattern in FIG. 4) drawn in the state where the application start position A set in the program and the actual application start point deviate from each other. Consequently, a defect, such as a narrow part (see the top in FIG. 4), a discontinuous part, and a bulged part (see the bottom in FIG. 4) because of the excess paste material, occurs at a connection part depending on the difference in the amount of deviation in position of the application start point “a”.

Therefore, in the paste applicator 1 in the embodiment, as illustrated in FIG. 5, the actual application start point “a” is detected by the detection sensor 6 immediately before the application is completed, and an application terminating operation start point “b” is calculated from a separation distance (separation distance on a plane) L1 between the detection sensor 6 and the nozzle 4b measured in advance and the application speed. Then, when the nozzle 4b reaches the application terminating operation start position b, the paste applicator 1 performs the application terminating operation. Meanwhile, the separation distance L1 in FIG. 5 is a separation distance between the center line of the nozzle 4b and the center line of the detection sensor 6.

Here, the nozzle 4b and the detection sensor 6 are arranged on one straight line in the plane. Then, the detection sensor 6 is arranged in a position where the detection sensor 6 can detect the application start point “a” in the direction in which application advances before the nozzle 4b passes over the application terminating operation start point “b”. That is, the detection sensor 6 is provided so as to be located on the downstream side of the nozzle 4b in the direction in which application advances on the final ling segment of the drawing pattern.

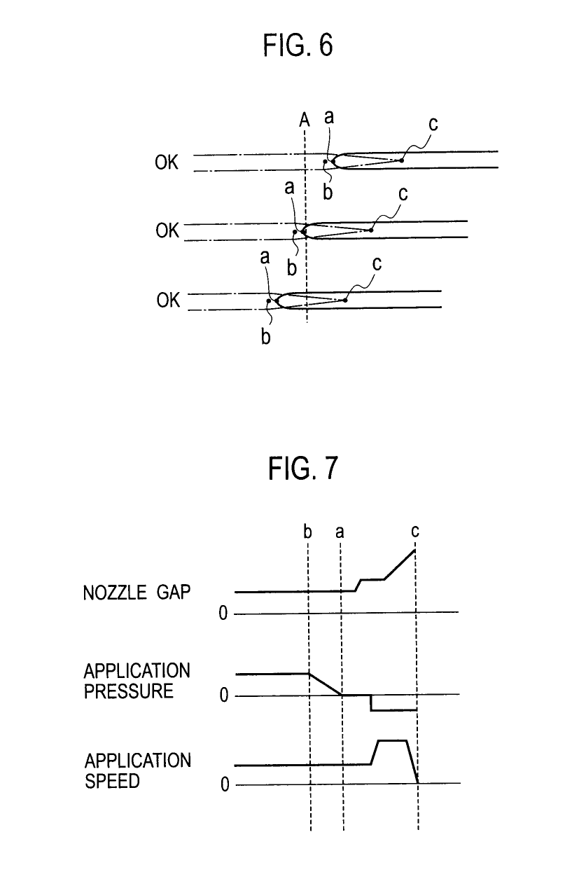

As illustrated in FIG. 6, the application terminating operation start point “b” varies according to the application start point “a” detected by the detection sensor 6. Because of this, the application terminating operation start point “b” is in a fixed position at all times from the actual application start point “a”. As a result, the shape of the connection part is prevented from being disturbed resulting from the deviation in position of the application start point “a” and further, the variations in the length of the overlapped paste material at the application start point “a” and an application end point “c” are suppressed.

In the application terminating operation described above, as illustrated in FIG. 7, when the nozzle 4b reaches the application terminating operation start point “b”, the nozzle gap, the application pressure (amount of material to be pushed out), and the application speed are controlled according to the program set in advance and the shape of the connection part is adjusted. As to the setting of each control parameter, evaluation is carried out in advance in accordance with the characteristics of the paste material, and the timing and setting value of each control parameter are determined. Meanwhile, the control parameters illustrated in FIG. 7 are an example when the discharge head 4 is of pneumatic type and also when the discharge head 4 is of mechanical type, the setting of necessary control parameters is performed similarly.

Next, the applying operation performed by the paste applicator 1 will be explained in detail. Here, as an example of a drawing pattern (paste pattern) of the paste material, a case where a drawing pattern P is drawn in the form of a closed rectangular ring (in the form of a loop) is explained.

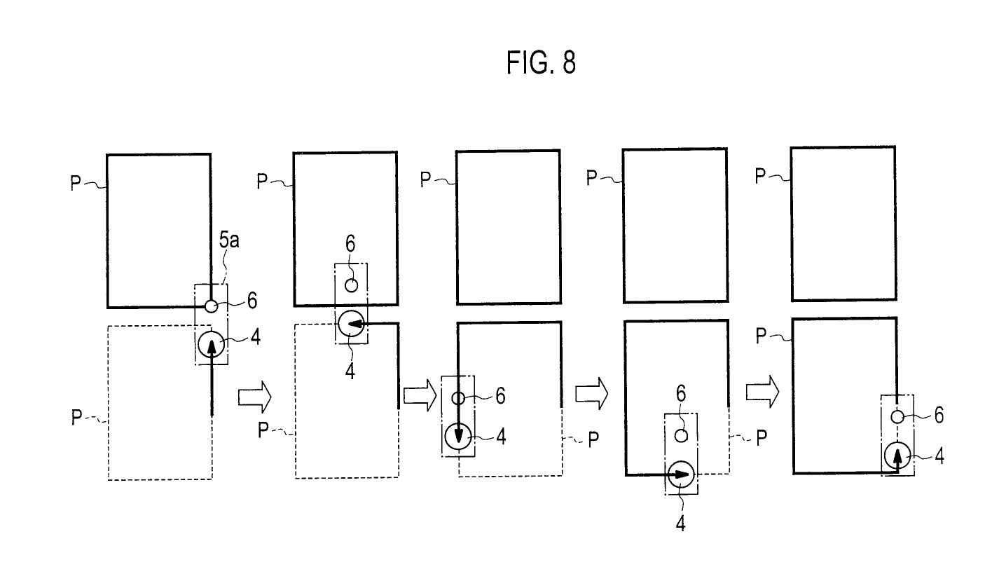

As illustrated in FIG. 8, for example, the paste applicator 1 applies the paste material in the form of a line counterclockwise on the substrate K on the stage 2 and sequentially draws the drawing pattern P in the form of a closed rectangular loop. The drawing pattern P in the form of the closed rectangular loop has four line segments and four corner parts.

First, the controller 7 controls the stage driver 3 based on the application information and various programs, causes the nozzle 4b of the discharge head 4 to oppose the application start position A of the program, and adjusts the nozzle gap by controlling the head driver 5. After that, the controller 7 causes the paste material to be discharged from the tip end of the nozzle 4b while relatively moving the nozzle 4b and the substrate K on the stage 2 along the surface of the substrate K. In this manner, the drawing pattern P in the form of the closed rectangular loop is drawn on the substrate K on the stage 2. Meanwhile, the application start point “a” is in a position on the way of the first line segment (on the straight line that passes through the nozzle 4b and the detection sensor 6) of the drawing pattern P.

Furthermore, the controller 7 obtains the application terminating operation start point “b” of the paste material according to the application start point “a” detected by the detection sensor 6 during the discharge of the paste material. In more detail, the controller 7 obtains and sets the application terminating operation start point “b” based on the separation distance L1 between the detection sensor 6 and the nozzle 4b and the application speed (the relative speed between the substrate K and the nozzle 4b). Subsequently, when the current position of the nozzle 4b on the surface of the substrate K agrees with the application terminating operation start point “b” obtained, the controller 7 starts the application terminating operation.

In the application terminating operation, for example, as illustrated in FIG. 7, first the application pressure (discharge pressure of the nozzle 4b) is reduced gradually according to the movement of the nozzle 4b from the application terminating operation start point “b” to the application start point “a”. After that, the application speed (relative speed between the substrate K and the nozzle 4b) and the nozzle gap (separation distance between the surface of the substrate K and the nozzle 4b) are also controlled until the nozzle 4b reaches the application end point “c” based on the conditions set in advance. Here, the application pressure is reduced to zero or lower in FIG. 7 in order to prevent the paste from dripping from the nozzle 4. Further, the application speed is increased rapidly in order to prevent the paste from being drawn by the nozzle 4b.

As illustrated in FIG. 8, the detection sensor 6 is provided so as to move together with the discharge head 4, and therefore, a state occurs where the paste material already used in completing the drawing or the paste material during the application is detected. In order to avoid such an erroneous detection and to prevent paste material other than at the application start point “a” from being detected, a function to set a region where the detection result of the detection sensor 6 is effective is provided by the application program (or hardware). For example, the application program is set so that the controller 7 uses only the detection result in the final line segment of the drawing pattern.

In detail, the controller 7 determines whether or not the position of the detection sensor 6 is in a region where the detection result of the detection sensor 6 is effective. Then, when the detection sensor 6 is in the effective region, the detection result of the detection sensor 6 is used. Meanwhile, determining whether or not the position of the detection sensor 6 is in the region where the detection result of the detection sensor 6 is effective is equivalent to determining whether or not the detection sensor 6 is located on the upstream side of the application start point “a” in the direction of the movement of the discharge head 4. Consequently, the controller 7 uses the application start point “a” detected by the detection sensor 6 only when the detection sensor 6 is determined to be located on the upstream side of the application start point “a” in the direction of the movement of the discharge head 4 as a result.

In this manner, the paste applicator 1 detects the application start point “a” by the detection sensor 6, and calculates the application terminating operation start point “b”, and starts the application terminating operation when the nozzle 4b is located on the application terminating operation start point “b”. Because of this, the application terminating operation start point “b” is calculated based on the actual application start point “a”, and the application terminating operation start point “b” is in a fixed position at all times from the actual application start point “a”. Therefore, the influence on the shape of the connection part by the variations in the position of the application start point “a” is removed and further, the variations in the length of the overlapped paste material at the application start point “a” and the application end point “c” are suppressed. As a result, it is possible to keep stable the shape of the connection point of the paste pattern in the form of the closed ring and to carry out application of the paste material without any of the narrow part, the bulged part, and the discontinuous part. That is, it is possible to keep stable the shape of the application section at the connection part as well as the shapes of the other application parts.

Here, when a resin is used as the paste material, even if the shape of the connection part is rather poor, the connection part is crushed somewhat when the substrate K and another substrate are bonded. Because of this, the occurrence of defective sealing and the like can be suppressed to a certain degree. However, when glass frit is used as the paste material, the substrate K and another substrate are bonded after temporarily drying and baking the glass frit, and therefore, the connection part hardly changes its shape. Because of this, it is important to keep stable the shape of the connection part at the time of application.

Meanwhile, the application terminating operation start point “b” can be calculated each time of pattern application, but it may also be possible to calculate the application terminating operation start point “b”, for example, in the first pattern and store a separation distance (separation distance on the plane) L2 (refer to FIG. 5) between the calculated application terminating operation start point “b” and the position of the nozzle 4b when the detection sensor 6 detects the application start point “a” in the storage section and use the separation distance L2 stored in the storage section in the next pattern in accordance with the detection of the application start point “a”. In this case, when the application start point “a” in the next pattern is detected by the detection sensor 6 and the movement distance of the discharge head 4 from the time of the detection agrees with the above-described separation distance L2, the discharge head 4 is located on the application terminating operation start point “b” as a result.

As described above, according to the embodiments, it becomes possible to adjust the shape of the connection part of a paste pattern in the form of a closed ring by detecting the application start point “a” by the detection sensor 6 during the discharge of the paste material and setting the application terminating operation start point “b” of the paste material in accordance with the application start point “a”. Because of this, it is possible to prevent the shape of the connection part from being disturbed resulting from the deviation in position of the application start point “a” and to suppress the variations in the length of the overlapped paste material at the application start point “a” and the application end point “c”. As a result, the occurrence of the discontinuity of the line, the narrowness of the line, and the bulge of the line can be prevented and thus, it is possible to keep stable the shape of the connection part of the paste pattern in the form of the closed ring.

Furthermore, the control device 7 obtains the application terminating operation start point b based on the separation distance L1 on the plane between the detection sensor 6 and the discharge head 4 and the relative speed (application speed) between the substrate K and the discharge head 4 in accordance with the application start point a detected by the detection sensor 6 during the discharge of the paste material. Then, when the discharge head 4 is located on the application terminating operation start point b obtained, the control device 7 starts the application terminating operation to change at least one of the relative speed (application speed) between the substrate K and the discharge head 4, the separation distance (nozzle gap) between the surface of the substrate K and the discharge head, and the discharge pressure (application pressure) of the discharge head 4. Because of this, even when the application start point a deviates each time pattern application is carried out, the application terminating operation start point b is in a fixed position at all times from the actual application start point a. As a result, it is possible to prevent without fail the shape of the connection part from being disturbed resulting from the deviation in position of the application start point “a” and further, it is possible to suppress without fail the variations in the length of the overlapped paste material at the application start point “a” and the application end point “c”.

The detection sensor 6 is provided so as to relatively move with respect to the substrate K together with the discharge head 4, and the controller 7 determines whether or not the detection sensor 6 is located on the upstream side of the application start point “a” in the direction of the movement of the discharge head 4. Then, only when it is determined that the detection sensor 6 is located on the upstream side of the application start point “a” in the direction of the movement of the discharge head 4, the application start point “a” detected by the detection sensor 6 is used. Because of this, the detection result when the paste material already used in completing the drawing or the paste material during application is detected is not used, and the paste materials other than that at the application start point “a” are substantially prevented from being detected. Consequently, the application terminating operation start point “b” is obtained accurately and an erroneous operation is prevented as a result.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the embodiments described above, the paste material is applied while moving only the stage 2 on which the substrate K is mounted in accordance with the drawing pattern P. However, this is not limited and it may also be possible to apply the paste material while fixing the stage 2 and moving only the discharge head 4 in accordance with the drawing pattern P or to apply the paste material while moving both the stage 2 and the discharge head 4 based on the drawing pattern P and there are no restrictions on the drive method of drawing. Further, it may also be possible to provide two or more discharge heads 4, and the number of the discharge heads 4 is not limited.

Moreover, in the embodiments described above, in order to simplify the drive configuration of the device and to downsize the device, the detection sensor 6 is moved together with the discharge head 4, but this is not limited and it may also be possible to individually move the discharge head 4 and the detection sensor 6. In this case, the detection sensor 6 is provided so as not to obstruct the movement of the discharge head 4, the application start point “a” is detected during the application of paste by the detection sensor 6, and the application terminating operation start point “b” is obtained from this point using the separation distance L1 and the application speed in the same manner as that described above. Then, the application terminating operation start point “b” obtained is stored in the storage section and used at the final line segment of the drawing pattern. Furthermore, in FIG. 8, when the positions of the discharge head 4 and the detection sensor 6 are exchanged, immediately after the discharge head 4 passes over the application start point “a”, the detection sensor 6 detects the application start point “a” as a result. In this case also, the application terminating operation start point “b” is obtained from the detected application start point “a” using the separation distance L1 and the application speed in the same manner as that described above and the application terminating operation start point “b” obtained is stored in the storage section, and then it is used at the final line segment of the drawing pattern.

What is claimed is:

1. A paste applicator comprising:
a discharger that discharges paste material toward a surface of an object to be applied;
a driver that relatively drives the object to be applied and the discharger along the surface of the object to be applied;
a detector that detects an application start point of the paste material discharged from the discharger and applied to the surface of the object to be applied; and
a controller that controls the discharger and the driver so that the paste material is applied to the surface of the object to be applied in a form of a closed ring, the controller that sets an application terminating operation start point of the paste material in accordance with the application start point detected by the detector during the discharge of the paste material.

2. The paste applicator according to claim 1, wherein
the controller obtains the application terminating operation start point based on a separation distance on a plane between the detector and the discharger and a relative speed between the object to be applied and the discharger in accordance with the application start point detected by the detector during the discharge of the paste material, and starts an application terminating operation to change at least one of the relative speed between the object to be applied and the discharger, a separation distance between the surface of the object to be applied and the discharger, and a discharge pressure of the discharger, when the discharger is located on the application terminating operation start point obtained.

3. The paste applicator according to claim 1, wherein
the detector is provided so as to relatively move with respect to the object to be applied together with the discharger,
the controller determines whether or not the detector is located on an upstream side of the application start point in the direction of the movement of the discharger, and
only when the detector is determined to be located on the upstream side of the application start point in the direction of the movement of the discharger, the application start point detected by the detector is used.

4. The paste applicator according to claim 2, wherein
the detector is provided so as to relatively move with respect to the object to be applied together with the discharger,
the controller determines whether or not the detector is located on an upstream side of the application start point in the direction of the movement of the discharger, and
only when the detector is determined to be located on the upstream side of the application start point in the direction of the movement of the discharger, the application start point detected by the detector is used.

5. A paste applying method comprising a step of applying paste material to a surface of an object to be applied in a form of a closed ring by relatively moving the object to be applied and a discharger along the surface of the object to be applied, the discharger that discharges the paste material toward the surface of the object to be applied, wherein
the step of applying the paste material comprises:
a step of detecting an application start point of the paste material discharged from the discharger and applied to the surface of the object to be applied; and
a step of setting an application terminating operation start point of the paste material according to the application start point detected during the discharge of the paste material.

6. The paste applying method according to claim 5, wherein
the step of setting the application terminating operation start point of the paste material comprises:
a step of obtaining the application terminating operation start point based on a separation distance on a plane between the detector and the discharger and the relative speed between the object to be applied and the discharger in accordance with the application start point detected during the discharge of the paste material; and
a step of starting an application terminating operation to change at least one of the relative speed between the object to be applied and the discharger, the separation distance between the surface of the object to be applied and the discharger, and the discharge pressure of the discharger, when the discharger is located on the application terminating operation start point obtained.
